(19) United States
(12) Patent Application Publication
(10) Pub. No.: US 2025/0367922 A1
(43) Pub. Date: Dec. 4, 2025

(54) LIQUID DROPLET EJECTING APPARATUS

(71) Applicant: BROTHER KOGYO KABUSHIKI KAISHA, Nagoya (JP)

(72) Inventors: Haruhisa TAKAYAMA, Nagoya (JP); Atsushi ITO, Nagoya (JP); Yuya KATO, Nagoya (JP)

(73) Assignee: BROTHER KOGYO KABUSHIKI KAISHA, Nagoya (JP)

(21) Appl. No.: 19/184,049

(22) Filed: Apr. 21, 2025

(30) Foreign Application Priority Data
May 29, 2024 (JP) 2024-086954

(51) Int. Cl. B41J 2/045; B41J 2/155

(52) U.S. Cl. CPC B41J 2/04561; B41J 2/04586; B41J 2/155; B41J 2202/21

(57) ABSTRACT

A liquid droplet ejecting apparatus includes: a head having a nozzle surface, the nozzle surface having a plurality of nozzles configured to eject liquid droplets; a detecting device having a light source configured to emit a light beam toward a flying space through which the liquid droplets ejected from the nozzles fly, and a detecting element configured to detect the light beam and disposed such that the flying space is interposed between the light source and the detecting element; a rotating device configured to rotate the detecting device about a predetermined center of rotation as a base point such that an emission direction of the light beam changes in a plane parallel to the nozzle surface; a moving device configured to move the detecting device in a predetermined outward route direction and a predetermined homeward route direction; and a controller.

### REFERENCE TO RELATED APPLICATIONS

This application claims priority from Japanese Patent Application No. 2024-086954 filed on May 29, 2024. The entire content of the priority application is incorporated herein by reference.

### BACKGROUND ART

Conventionally, a printing apparatus is known, which includes an ejection head to be reciprocatively scanned, and a light source. The light source irradiates, with light, liquid droplets ejected from the ejection head in an outward route and a homeward route. The light source is disposed so that the optical axis of the light emitted from the light source is inclined with respect to a nozzle array of the ejection head.

### SUMMARY

However, in the conventional technique described above, although the presence or absence of the ejected liquid droplets can be detected, the ejection curvature cannot be detected with respect to the normal flying direction of the liquid droplets. That is, whether a flying direction of the liquid droplets is deflected while overlapping the optical axis of the light cannot be detected. Therefore, the plane coordinates of the ejected liquid droplets cannot be detected.

In view of the above-described situation, the present disclosure aims to provide a liquid droplet ejecting apparatus capable of highly accurately determining presence or absence of the ejection curvature of the liquid droplets.

A liquid droplet ejecting apparatus according to the present disclosure includes: a head having a nozzle surface, the nozzle surface having a plurality of nozzles configured to eject liquid droplets onto a printing medium; a detecting device having a light source and a detecting element, the light source being configured to emit a light beam toward a flying space through which the liquid droplets ejected from the nozzles fly, the detecting element being disposed such that the flying space is interposed between the detecting element and the light source and configured to detect the light beam; a rotating device configured to rotate the detecting device about a predetermined center of rotation as a base point, such that an emission direction of the light beam changes in a plane parallel to the nozzle surface; a moving device configured to move the detecting device in a predetermined outward route direction and a predetermined homeward route direction; and a controller. The controller is configured to execute: a first rotating process of setting the detecting device to a first attitude by causing the rotating device to rotate the detecting device about the center of rotation as the base point, such that an angle of an optical axis of the light beam with respect to the head is a first angle; a first receiving process of receiving a first light-receiving amount relevant to a first light beam detected by the detecting element by causing the light source to irradiate the liquid droplets ejected from the nozzles to the flying space with the light beam as the first light beam, while causing the moving device to move the detecting device in the first attitude in the outward route direction; a second rotating process of setting the detecting device to a second attitude by causing the rotating device to rotate the detecting device about the center of rotation as the base point, such that the angle of the optical axis with respect to the head is a second angle which is different from the first angle; a second receiving process of receiving a second light-receiving amount relevant to a second light beam detected by the detecting element by causing the light source to irradiate the liquid droplets ejected from the nozzles to the flying space with the light beam as the second light beam, while causing the moving device to move the detecting device in the second attitude in the homeward route direction; and a calculating process of calculating an ejection curvature amount of the liquid droplets with respect to a normal flying direction based on the first light-receiving amount and the second light-receiving amount.

According to the present disclosure, the light source of the detecting device, which is in the first attitude, irradiates the liquid droplets ejected from the nozzles with the first light beam, and the light source of the detecting device, which is in the second attitude, irradiates the liquid droplets ejected from the nozzles with the second light beam. Further, the presence or absence of the ejected liquid droplets and the volume of the liquid droplet can be detected by detecting the first light-receiving amount. Furthermore, whether a flying direction of the detected liquid droplets is deflected while overlapping the optical axis of the first light beam can be detected by detecting the second light-receiving amount. In other words, the extent at which the liquid droplet flies while being deflected with respect to the direction of the optical axis of the first light beam (depth direction of the optical axis) can be detected. In this way, in a case where only the first light-receiving amount is used, whether the flying direction of the liquid droplets is deflected while overlapping the optical axis of the first light beam cannot be determined. However, by using the second light-receiving amount relevant to the second light beam, the ejection curvature amount of the liquid droplets with respect to the normal flying direction can be calculated highly accurately.

According to the present disclosure, the liquid droplet ejecting apparatus capable of highly accurately determine the presence and the absence of the ejection curvature of the liquid droplets can be provided.

### BRIEF DESCRIPTION OF DRAWINGS

FIG. 1 is a plan view depicting a liquid droplet ejecting apparatus according to an embodiment.

FIG. 2 is a block diagram depicting an example of constitutive components of a printing apparatus in which the liquid droplet ejecting apparatus depicted in FIG. 1 is included.

FIG. 3 is a bottom view depicting the configuration of a line head.

FIG. 4 is a view depicting a situation in which flying ink droplets ejected from an ejection head are irradiated with a laser beam.

FIG. 5 is a plan view depicting a light source and a detecting element corresponding to the light source in a situation wherein a detecting device is in a first attitude and the light source and the detecting element corresponding to the light source in a situation wherein the detecting device is in a second attitude.

FIG. 6 is a view depicting a relationship between the position of a center of rotation of a frame and the distance required for the rotation of the frame.

FIG. 7A and FIG. 7B are views depicting examples of the disposition of the light source and the detecting element with respect to the line head.

FIG. 8A and FIG. 8B are views each depicting an example of the disposition of the light source and the detecting element between one line head and another line head which are adjacent to each other.

FIG. 9 is a view depicting an example of the disposition of the light source and the detecting element with respect to a nozzle surface.

FIG. 10 is a view depicting an example of the disposition of the light source and the detecting element with respect to a conveyance direction.

FIG. 11 is a view depicting an emission direction in which the laser beam is emitted by the light source.

FIG. 12 is a view depicting an example of a light-shielding part disposed between the nozzle surface and the optical axis.

FIG. 13 is a view depicting an example of a light-shielding part disposed between the nozzle surface and the optical axis.

FIG. 14 is a view depicting the position of the optical axis of the light source between one line head and another line head which are adjacent to each other.

FIG. 15 is a view depicting the emission timing of the laser beam in each of units.

### DESCRIPTION

A liquid droplet ejecting apparatus according to an embodiment of the present disclosure will be described below with reference to the drawings. The liquid droplet ejecting apparatus described below is merely an embodiment of the present disclosure. Therefore, the present disclosure is not limited to the embodiment described below; any addition, deletion, and change can be made within a range not departing from the gist or essential characteristics of the present disclosure.

### First Embodiment

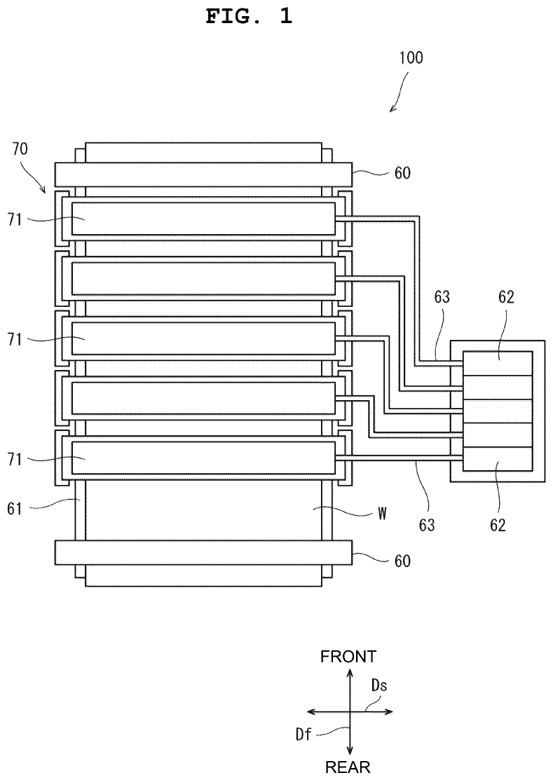

FIG. 1 is a plan view depicting a liquid droplet ejecting apparatus 100 according to an embodiment. The liquid droplet ejecting apparatus 100 of the present embodiment is based on the line head system. In FIG. 1, the directions which are orthogonal to each other are referred to as “first direction Df” and “second direction Ds”. In the present embodiment, the first direction Df corresponds to a conveyance direction of a printing medium W, and the second direction Ds corresponds to a crossing the direction which crosses the conveyance direction. In the following description, the reference symbol “Df” is referred to as “conveyance direction”, and the reference symbol “Ds” is referred to as “crossing direction”.

As depicted in FIG. 1, the liquid droplet ejecting apparatus 100 includes a line head group 70, a pair of conveyance rollers 60, a platen 61, a plurality of storage tanks 62, and a plurality of tubes 63.

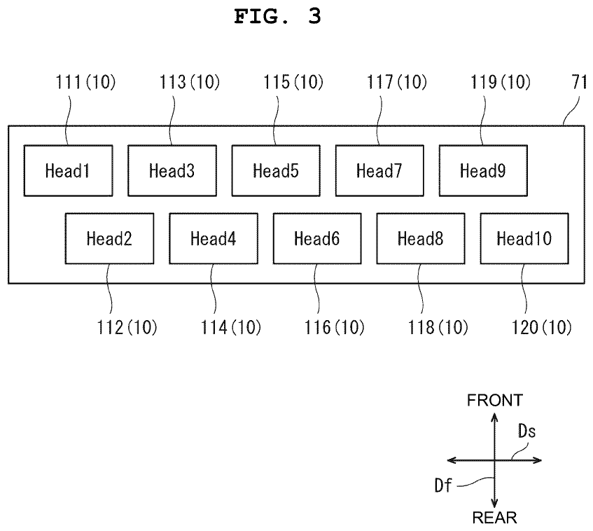

The line head group 70 has, for example, five line heads 71. The number of the line heads 71 included in the line head group 70 is not limited to five, and the number can be appropriately set. The line heads 71 are disposed, for example, corresponding to colors of inks. The line heads 71 are disposed and aligned at substantially equal intervals in the conveyance direction Df. The respective line heads 71 extend in the crossing direction Ds. A plurality of ejection heads 10 (FIG. 3) which will be described later are disposed so that each of the plurality of ejection heads 10 corresponds to one of the line heads 71. Note that each of the line heads 71 corresponds to the head. Note, however, that a serial head (including a configuration including a plurality of line-shaped ejection heads which are aligned) may be used, rather than using the line head 71.

The platen 61 supports the printing medium W from below. For example, the platen 61 has a predetermined thickness, and the platen 61 is constructed of a rectangular plate member which is long in the conveyance direction Df.

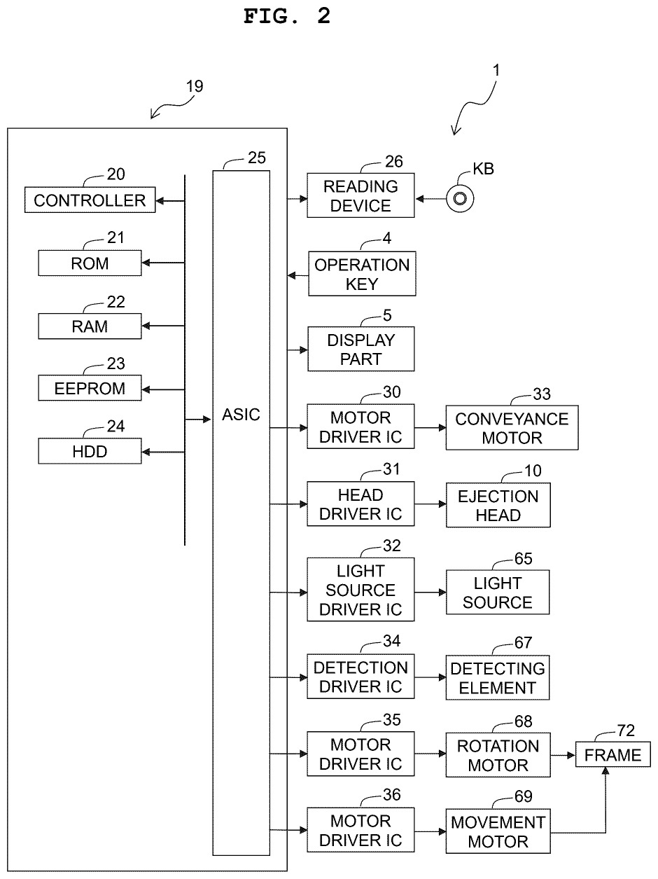

The pair of conveyance rollers 60 extend in the crossing direction Ds. The dimension in the crossing direction Ds of each of the conveyance rollers 60 is larger than the dimension in the crossing direction Ds of the printing medium W. One of the pair of conveyance rollers 60 is connected to a conveyance motor 33 (FIG. 2) described later, and is disposed on one side (for example, on the front side) in the conveyance direction Df with respect to the platen 61. The other of the pair of conveyance rollers 60 is disposed on the other side (for example, on the rear side) in the conveyance direction Df with respect to the platen 61. In a case where the conveyance motor 33 is driven, the pair of conveyance rollers 60 are rotated to thereby convey the printing medium W on the platen 61 in the conveyance direction Df. Note that in the present embodiment, as an example, the printing medium W is conveyed from the front toward the rear.

The inks are stored in the plurality of storage tanks 62. The plurality of storage tanks 62 are disposed so that each of the plurality of storage tank 62 corresponds to one type of the inks. For example, five storage tanks 62 are provided and each of the five storage tanks 62 stores one of the black, yellow, cyan, magenta, and white inks corresponding thereto respectively. A color image is printed by ejecting ink droplets of the inks of four colors which are black, yellow, cyan, and magenta onto the printing medium W. Further, an undercoat is formed by ejecting ink droplets of the white ink onto the printing medium W.

The plurality of tubes 63 are disposed so that each of the plurality of tubes 63 corresponds to one of the plurality of storage tanks 62 corresponding thereto. The plurality of tubes 63 connect the plurality of storage tanks 62 and the plurality of ejection heads 10 included in the line heads 71.

FIG. 2 is a block diagram depicting an example of constitutive components of the printing apparatus 1 in which the liquid droplet ejecting apparatus 100 depicted in FIG. 1 is included.

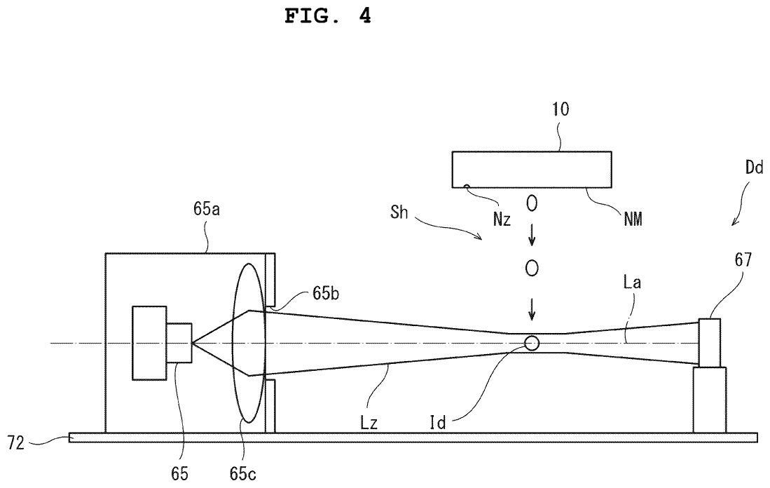

As depicted in FIG. 2, the printing apparatus 1 includes an operation key 4, a display part 5, and a reading device 26. Other than the constitutive components described above, the liquid droplet ejecting apparatus 100 includes the ejection heads 10, a controller unit 19, the conveyance motor 33, motor driver ICs 30, 35 and 36, a head driver IC 31, a light source driver IC 32, and a detection driver IC 34. Further, the liquid droplet ejecting apparatus 100 includes a detecting device Dd which will be described later (FIG. 4), a rotation motor 68, a movement motor 69, and a frame 72. The detecting device Dd has a light source 65, a detecting element 67, and the frame 72. Note that the rotation motor 68, the frame 72, and a connecting mechanism, such as a gear, etc., which is not illustrated in the drawings and which connects the rotation motor 68 and the frame 72 correspond to the rotating device. The movement motor 69, the frame 72, and a non-illustrated ball screw or a rack and pinion, etc., which connects the movement motor 69 and the frame 72 correspond to the moving device.

The operation key 4 receives input of an operation performed by a user. The display part 5 is constructed of, for example, a touch panel, and the display part 5 displays predetermined information. A part of the display part 5 also functions as an operation key. The controller unit 19 realizes a printing function based on input from the operation key 4 or input from outside via a non-illustrated communication interface, and the controller unit 19 controls the display of the display part 5.

The controller unit 19 has a controller 20 which is composed of CPU, memories (ROM 21, RAM 22, EEPROM 23, HDD 24), and ASIC 25. The controller 20 is connected to each of the memories, and the controller 20 controls the respective driver ICs 30 to 32, 34 to 36, the display part 5, and the reading device 26.

The controller 20 executes various functions by executing a predetermined processing program stored in the ROM 21. The controller 20 may be mounted as one processor on the controller unit 19, or the controller 20 may be mounted as a plurality of processors which cooperate with each other. The processing program is read by the reading device 26 from a recording medium KB including, for example, a computer-readable magneto-optical disk, etc., or a USB flash memory, etc., and the processing program is stored in the ROM 21. For example, image data received from any external apparatus and result of calculation by the controller 20, etc., are stored in the RAM 22. Various multiple initial setting information inputted by the user are stored in the EEPROM 23. Various pieces of information are stored in the HDD 24.

The motor driver ICs 30, 35 and 36, the head driver IC 31, the light source driver IC 32, and the detection driver IC 34 are connected to the ASIC 25. In a case where a printing job is received from the user, the controller 20 outputs a printing command to the ASIC 25 based on the processing program. The ASIC 25 controls the respective driver ICs 30 to 32, 34 to 36 based on the printing command. The controller 20 causes the printing medium W on the platen 61 to move in the conveyance direction Df by driving the conveyance motor 33 by the motor driver IC 30.

The controller 20 converts the image data obtained from the external apparatus, etc., into ejection data by which the ink droplets are ejected to the printing medium W. The controller 20 causes the ejection head 20 to eject the ink droplets by the head driver IC 31 based on the converted ejection data. Further, the controller 20 controls the light source 65 by the light source driver IC 32, and the controller 20 controls the detecting element 67 by the detection driver IC 34. Further, the controller 20 controls the rotation motor 68 by the motor driver IC 35. In a case where the rotation motor 68 is controlled by the controller 20, the frame 72, which supports the light source 65 and the detecting element 67, is thereby rotated. Accordingly, an emission direction in which a laser beam Lz is emitted (FIG. 4) and which will be described later is changed in a plane parallel to a nozzle surface NM (FIG. 4) which will be described later. Further, the controller 20 controls the movement motor 69 by the motor driver IC 36. In a case where the movement motor 69 is controlled by the controller 20, the frame 72, which supports the light source 65 and the detecting element 67, is moved thereby in a predetermined outward route direction and a predetermined homeward route direction. Note that the rotation and the movement of the frame 72 will be described in detail later.

FIG. 3 is a bottom view depicting the configuration of the line head 71. As depicted in FIG. 3, the line head 71 includes ten ejection heads 10, as an example. For example, an ink-jet head, which ejects, for example, ink droplets as the liquid droplets, can be adopted as the ejection head 10. Note, however, that the ejection head 10 is not limited to the above-described ink-jet head.

Among the ten ejection heads 10, five ejection heads 10 are disposed on the upstream side in the conveyance direction Df, and the remaining five ejection heads 10 are disposed on the downstream side in the conveyance direction Df. The ejection heads 111, 113, 115, 117 and 119 are disposed as the ejection heads 10 on the upstream side in the conveyance direction Df. Further, the ejection heads 112, 114, 116, 118 and 120 are disposed as the ejection heads 10 on the downstream side in the conveyance direction Df. The respective ejection heads 10, which are disposed on the upstream side, are disposed at approximately equal intervals. The respective ejection heads 10, which are disposed on the downstream side, are disposed at approximately equal intervals, and the respective ejection heads 10, which are disposed on the downstream side, are disposed while being shifted by predetermined distances in the crossing direction Ds with respect to the respective ejection heads 10 which are disposed on the upstream side. That is, the plurality of ejection heads 10 of the line head 71 are disposed in a zigzag form in the crossing direction Ds. Note that the disposition of the respective ejection heads 10 is not limited to the zigzag form.

FIG. 4 is a view depicting a situation in which the flying ink droplets Id ejected from the ejection head 10 are irradiated with the laser beam Lz. In the present embodiment, the laser beam Lz corresponds to the light beam. As depicted in FIG. 4, the ejection head 10 has the nozzle surface NM. A plurality of nozzles Nz are open in the nozzle surface NM. The ink droplets Id are ejected from the respective nozzles Nz to the printing medium W. Note that only one nozzle Nz is depicted in FIG. 4 to make the drawing simple.

The light source 65 is disposed on one side, with the position of the ejection head 10 as the reference, in the direction parallel to the optical axis La of the laser beam Lz emitted from the light source 65. The detecting element 67 is disposed on the other side, with the position of the ejection head 10 as the reference, in the above-described direction. A flying space Sh is positioned between the light source 65 and the detecting element 67. The light source 65 emits the laser beam Lz toward the flying space Sh through which the ink droplets Id ejected from the nozzle Nz fly. The light source 65 is disposed in a light source accommodating part 65a having the shape of a box. The light source accommodating part 65a has a slit 65b which is defined on the side of the emission direction of the laser beam Lz emitted from the light source 65. A lens 65c is disposed in the light source accommodating part 65a so that the slit 65b is covered by the lens 65 from the inner side of the light source accommodating part 65a. One lens or a plurality of lenses may be included separately from the lens 65c. The light source 65 and the detecting element 67 are supported by the frame 72. The frame 72 extends along the optical axis La of the laser beam Lz.

The ink droplets ID, which are flying in the flying space Sh after being ejected from the ejection head 10, are irradiated with the laser beam Lz which is emitted from the light source 65 and which is transmitted through the lens 65c. The detecting element 67 detects a light-receiving amount relating to the laser beam Lz after the laser beam Lz, which is emitted from the light source 65, passes through the flying space Sh. The controller 20 executes an ejection failure detection process of detecting ejection failure based on the comparison between a reference signal and a signal outputted from the detecting element 67. The detection failure includes, for example, abnormal velocity of the ink droplet Id, abnormal volume of the ink droplet Id, and ejection curvature (misdirection) of the ink droplet Id. Note that the ejection curvature means that the ink droplet Id flies in a direction which is different from the normal flying direction. A method of detecting the ejection curvature will be described below.

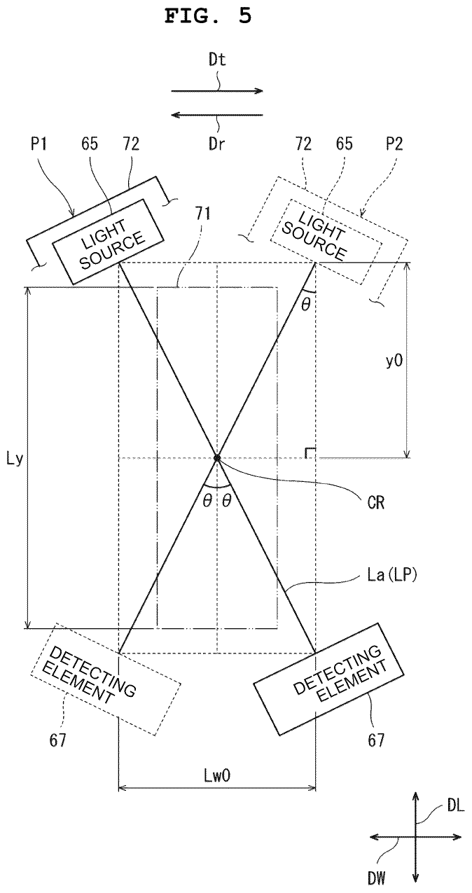

FIG. 5 is a plan view depicting a first attitude P1 and a second attitude P2 of the detecting device Dd. As depicted in FIG. 5, at first, the controller 20 causes the detecting device Dd to be in the first attitude P1 by rotating the frame 72 of the detecting device Dd about the center of rotation CR, as the base point, by the rotation motor 68. In the first attitude P1, the angle θ of the optical axis La with respect to the line head 71 is a first angle. For example, in a mode in which the light source 65 is disposed close to one end of the line head 71 in the longitudinal direction and the detecting element 67 is disposed close to the other end of the line head 71 in the longitudinal direction, in a plan view, the angle θ can be defined as an angle formed by the optical axis La and the long side of the line head 71 in the plan view. In this situation, in a case where the angle θ is 0°, the optical axis La and the long side of the line head 71 are parallel to each other. That is, in a case where the angle θ is 0°, the laser beam Lz is emitted from the light source 65 in the direction which is parallel to the long side of the line head 71. Note that the first angle as the angle θ is, for example, in a range of 10° to 30°.

After the controller 20 causes the detecting device Dd to be in the first attitude P1, the controller 20 causes the light source 65 to emit the laser beam Lz as the first light beam, and the ink droplets Id ejected from the respective nozzles Nz to the flying space Sh are irradiated with the laser beam Lz, while causing the frame 72 of the detecting device Dd to move in the outward route direction Dt by the movement motor 69. The irradiation of the ink droplets Id with the laser beam Lz is performed for all of the nozzles Nz. In this situation, the controller 20 receives a first light-receiving amount relating to the laser beam Lz corresponding to the first light beam as detected by the detecting element 67. Note that the outward route direction Dt is the direction which is parallel to the transverse direction of the line head 71 in a plan view, and the homeward route direction Dr described later is the direction which is opposite to the outward route direction Dt.

Next, the controller 20 rotates the frame 72 of the detecting device Dd by the rotation motor 68 about the center of rotation CR as the base point, and thus the detecting device Dd is in the second attitude P2. In the second attitude P2, the angle θ of the optical axis La with respect to the line head 71 is a second angle which is different from the first angle. The second angle as the angle θ is, for example, in a range of −10° to −30°. Note that in FIG. 5, the frame 72 which is in the second attitude P2 and the light source 65 and the detecting element 67 which are supported by the frame 72 are depicted by broken lines.

After the controller 20 causes the detecting device Dd to be in the second attitude P2, the controller 20 causes the light source 65 to emit the laser beam Lz as the second light beam, and the ink droplets Id ejected from the respective nozzles Nz to the flying space Sh are irradiated with the laser beam Lz, while causing the frame 72 of the detecting device Dd to move in the homeward route direction Dr by the movement motor 69. The irradiation of the ink droplets Id with the laser beam Lz is performed for all of the nozzles Nz. In this situation, the controller 20 receives a second light-receiving amount relating to the laser beam Lz corresponding to the second light beam detected by the detecting element 67.

The controller 20 calculates the ejection curvature amount with respect to the normal flying direction of the ink droplet Id based on the first light-receiving amount and the second light-receiving amount obtained by the method described above.

The position, at which the center of rotation CR is to be set, will now be described. In the present embodiment, the center of rotation CR is set in the optical path LP between the light source 65 and the detecting element 67. More specifically, as depicted in FIG. 5, the center of rotation CR exists in the central area of the optical path LP between the light source 65 and the detecting element 67. The central area is the area which includes the center of the optical path LP. In the present embodiment, the central area is as follows.

With reference to FIG. 5, it is assumed that the angle of the optical axis La with respect to the line head 71 is 0, the direction, which is parallel to the optical axis La in a case where the angle θ formed by the optical axis La and the long side of the line head 71 is 0° in a plan view, is the longitudinal direction DL, and the direction, which is orthogonal to the longitudinal direction DL, is DW. Further, it is assumed that the dimension in the longitudinal direction DL of the line head 71 is Ly, and the space in the longitudinal direction DL between the light source 65 and the center of rotation CR is y0. Further, the center of rotation CR is set to be the center of the optical path LP between the light source 65 and the detecting element 67. Further, it is assumed that the migration length in the direction DW of the detecting element 67, which is provided in a case where the frame 72 is rotated clockwise and counterclockwise about the center of rotation CR as the base point by the movement motor 69, is Lw0. In this situation, the center of rotation CR is set in the central area of the optical path LP. Further, in a case where the frame 72 is rotated about the center of rotation CR as the base point, a migration length Lw in the direction DW of the detecting element 67 can be calculated in accordance with the following expression (1). Note that the migration length Lw is the distance between a predetermined position (for example, the center in the longitudinal direction) of the detecting element 67 in a case where the detecting device Dd is in the first attitude P1 and a predetermined position of the detecting element 67 in a case where the detecting device Dd is in the second attitude P2.

$$Lw = ( \vert y 0 - ( Ly / 2 ) \vert + ( Ly / 2 ) ) \times tan θ \times 2 \qquad Expression ( 1 )$$

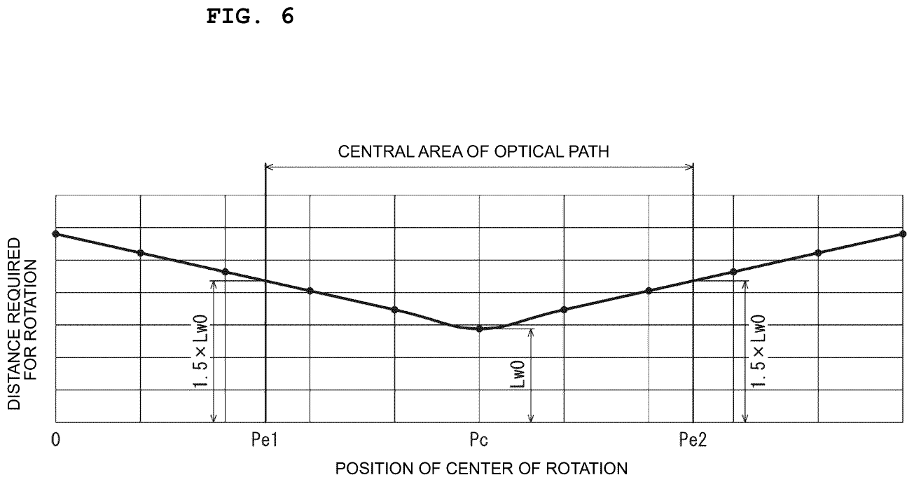

In the present embodiment, in order to save the space by maximally decreasing the migration length Lw, as depicted in FIG. 6, the center of rotation CR is set so that the migration length Lw is 1.5×Lw0 or less. In other words, the central area of the optical path LP, in which the center of rotation CR is to be set, includes a position Pc in the longitudinal direction DL of the center of rotation CR provided in a case where the center of rotation CR is set at the center of the optical path LP. More specifically, the position, at which the center of rotation CR is to be set in the central area of the optical path LP, is the position which is within a range from the position Pe1 which is closer to the light source 65 than the position Pc, to a position Pe2 which is closer to the detecting element 67 than the position Pc. Note that the migration length Lw (i.e., a migration length lw0), which is provided in a case where the center of rotation CR is located at the center (i.e., the position Pc) of the optical path LP, has the same value as the value of the migration length which is provided in the direction DW of the light source 65.

In this way, the center of rotation CR is set within the range from the position Pe1 to the position Pe2 in the longitudinal direction DL (in other words, within the range in which the migration length Lw is 1.5×Lw0 or less). Accordingly, the migration length Lw can be maximally decreased, and the space saving can be realized.

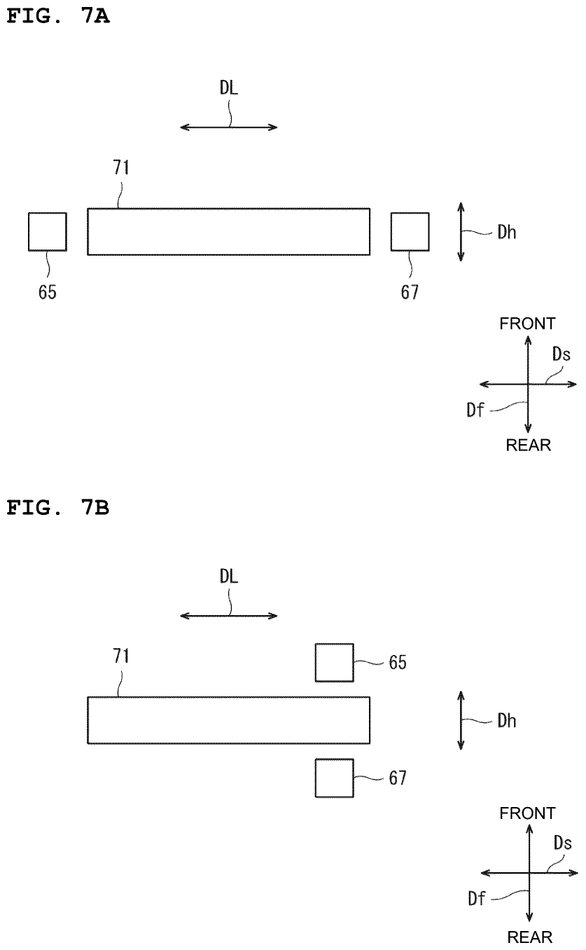

Next, the disposition of the light source 65 and the detecting element 67 with respect to the line head 71 will be described. FIG. 7A and FIG. 7B are views each depicting an example of the disposition of the light source 65 and the detecting element 67 with respect to the line head 71.

The line head 71 is formed to have a rectangular shape in a plan view. The line head 71 extends in the longitudinal direction DL of the line head 71 in the plan view. As depicted in FIG. 7A, the light source 65 is disposed close to one end of the line head 71 in the longitudinal direction DL in the plan view. Further, the detecting element 67 is disposed close to the other end of the line head 71 in the longitudinal direction DL. Note that in the aspect depicted in FIG. 7, the frame 72, which supports the light source 65 and the detecting element 67, reciprocatively moves in the transverse direction Dh during the execution of the detection process of detecting the ejection failure.

Alternatively, the light source 65 and the detecting element 67 may be disposed with respect to the line head 71 as follows. As depicted in FIG. 7B, the light source 65 is disposed close to one end of the line head 71 in the transverse direction Dh in a plan view. Further, the detecting element 67 is disposed close to the other end of the line head 71 in the transverse direction Dh. Note that in the embodiment depicted in FIG. 7B, the frame 72, which supports the light source 65 and the detecting element 67, reciprocatively moves in the longitudinal direction DL during the execution of the detection process of detecting the ejection failure.

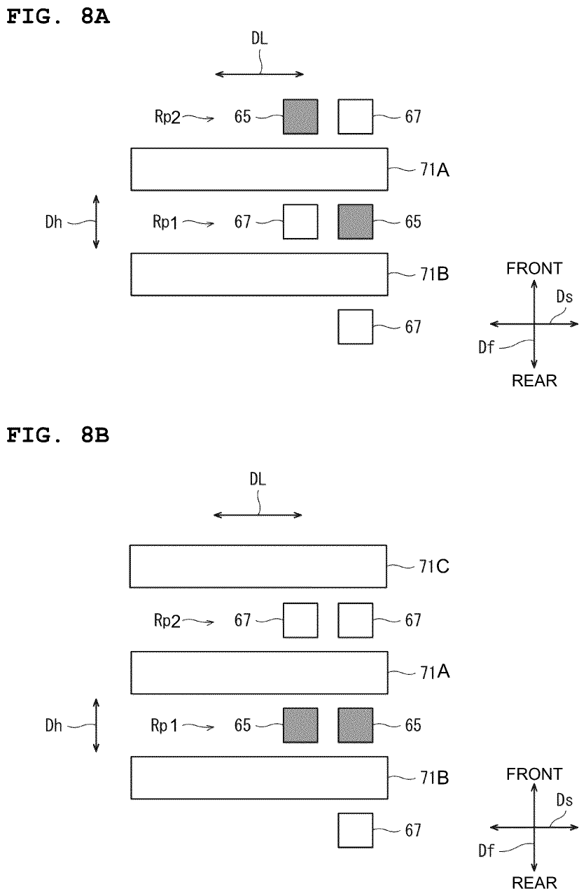

Next, FIG. 8A and FIG. 8B are views each depicting an example of the disposition of the light source 65 and the detecting element 67 between one line head 71 and another line head 71 which are adjacent to each other.

As depicted in FIG. 8A and FIG. 8B, a plurality of line heads 71 are disposed at predetermined intervals in the transverse direction Dh of the line head 71. The light source 65 and the detecting element 67 are disposed with respect to each of the line heads 71. In other words, the light source 65 and the detecting element 67 are provided corresponding to one of the line heads 71.

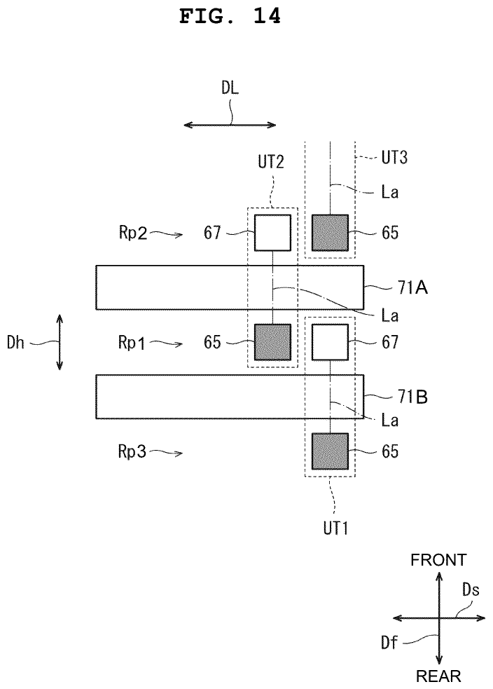

As depicted in FIG. 8A, the light source 65 corresponding to a line head 71B and the detecting element 67 corresponding to a line head 71A are disposed and aligned in the longitudinal direction DL of the line head 71 in the disposition area Rp1 between the line head 71A and the line head 71B which are adjacent to each other in the transverse direction Dh. In this context, in the present embodiment, in two disposition areas Rp1 and Rp2 which are adjacent to each other in the transverse direction Dh, the light source 65 and the detecting element 67 are disposed in this order from a location close to one end of the line head 71 in the longitudinal direction DL in the disposition area Rp1. In contrast to this, the detecting element 67 and light source 65 are disposed in this order from a location close to the one end of the line head 71 in the longitudinal direction DL in the disposition area Rp2. Note that in FIG. 8A, FIG. 8B, and FIG. 14 which will be described later, the light source 65 is depicted while being greyed in order to easily understand the disposition of the light source 65 with respect to the detecting element 67.

Alternatively, the light source 65 and the detecting element 67 may be disposed as follows between one line head 71 and another line head 71 which are adjacent to each other. As depicted in FIG. 8B, the light source 65 corresponding to the line head 71A and the light source 65 corresponding to the line head 71B are disposed and aligned in the longitudinal direction DL of the line head 71 in the disposition area Rp1 between the line head 71A and the line head 71B which are adjacent to each other in the transverse direction Dh. Accordingly, in the two disposition areas Rp1 and Rp2 which are adjacent to each other in the transverse direction Dh, the two light sources 65 are disposed in the disposition area Rp1 and the two light sources 65 are aligned in the longitudinal direction DL. In contrast to this, the detecting element 67 corresponding to the line head 71A and the detecting element 67 corresponding to the line head 71C are disposed in the disposition area Rp2 and aligned in the longitudinal direction DL. Accordingly, in the two disposition areas Rp1 and Rp2 which are adjacent to each other in the transverse direction Dh, the two detecting elements 67 are disposed and aligned in the longitudinal direction DL in the disposition area Rp2.

As described above, according to the liquid droplet ejecting apparatus 100, in a case where the detecting device Dd is in the first attitude P1, the light source 65 irradiates the ink droplets ejected from the nozzles Nz with the laser beam Lz as the first light beam, whereas in a case where the detecting device Dd is in the second attitude P2, the light source 65 irradiates the ink droplets ejected from the same nozzles Nz as the above-described nozzles Nz with the laser beam Lz as the second light beam. Further, the presence or absence of the ejected ink droplet and the volume of the ink droplet can be detected by detecting the first light-receiving amount relevant to the first light beam. Further, by detecting the second light-receiving amount relevant to the second light beam, detection can be made as to whether a flying direction of the detected ink droplets is deflected while overlapping the optical axis La of the laser beam Lz as the first light beam. In other words, the extent at which the flying of the ink droplet is deviated with respect to the direction of the optical axis La of laser beam Lz as the first light beam (depth direction of the optical axis) can be detected. As described above, in a case where only the first light-receiving amount is used, whether the flying direction of the ink droplets is deflected while overlapping the optical axis La of the laser beam Lz as the first light beam cannot be determined. However, in a case where the second light-receiving amount relevant to the second light beam is used, the ejection curvature amount of the ink droplets with respect to the normal flying direction can be calculated highly accurately.

Further, in the present embodiment, the center of rotation CR is positioned in the central area of the optical path LP between the light source 65 and the detecting element 67. Accordingly, space saving can be achieved regarding the movable area for the light source 65 and the detecting element 67.

Further, in the present embodiment, the light source 65 is disposed close to one end of the line head 71 in the longitudinal direction DL, and the detecting element 67 is disposed close to the other end of the line head 71 in the longitudinal direction DL, in a plan view. Accordingly, the ink droplets ejected from all of the nozzles Nz for constructing the respective nozzle arrays on each of the ejection heads 10 can be irradiated with the laser beam Lz. Accordingly, the total detection time for the ejection curvature can be shortened relating to all of the nozzles Nz.

Further, in the present embodiment, the light source 65 may be disposed close to the one end of the line head 71 in the transverse direction Dh, and the detecting element 67 may be disposed close to the other end of the line head 71 in the transverse direction DH, in a plan view. Accordingly, since the laser beam Lz, which is emitted from the light source 65, can have a short optical path length, the beam diameter of the laser beam Lz can be thinned. With this, the energy density of the laser beam Lz is raised, thereby improving the S/N ratio.

Furthermore, in the present embodiment, the light source 65 corresponding to one line head 71 and the detecting element 67 corresponding to another line head 71 are disposed and aligned in the longitudinal direction DL of the line head 71 in the disposition area between one line head 71 and another line head 71 which are adjacent to each other in the transverse direction Dh. Accordingly, the space saving can be achieved in the transverse direction Dh of the line head 71, as compared with a case in which the light source 65 and the detecting element 67 are disposed and aligned in the transverse direction Dh of the line head 71 in the disposition area between one line head 71 and another line head 71.

Moreover, in the present embodiment, the two light sources 65 may be disposed and aligned in the longitudinal direction DL of the line head 71 in one disposition area of the two disposition areas which are adjacent to each other in the transverse direction Dh. Further, the two detecting elements 67 may be disposed and aligned in the longitudinal direction DL of the line head 71 in the other disposition area of the two disposition areas which are adjacent to each other in the transverse direction Dh. With this, the space saving can be achieved in the transverse direction Dh of the line head 71, as compared with a case in which the two light sources 65 are disposed and aligned in the transverse direction Dh of the line head 71 in one disposition area, and the two detecting elements 67 are disposed and aligned in the transverse direction Dh of the line head 71 in the other disposition area. Furthermore, the noise is consequently reduced by disposing the light sources 65 together in the same disposition area and disposing the detecting elements 67 together in the same disposition area.

### Second Embodiment

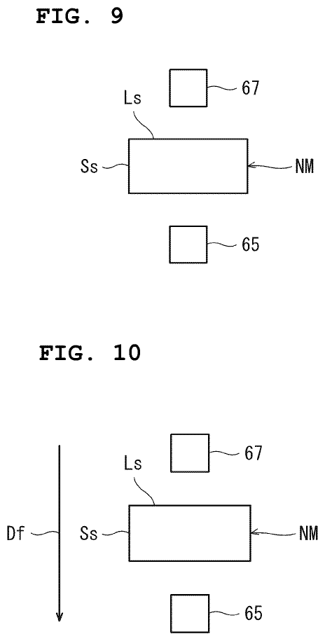

A second embodiment of the present disclosure will be described. FIG. 9 is a view depicting an example of the disposition of the light source 65 and the detecting element 67 with respect to the nozzle surface NM. FIG. 10 is a view depicting an example of the disposition of the light source 65 and the detecting element 67 with respect to the conveyance direction Df.

As depicted in FIG. 9 and FIG. 10, the nozzle surface NM has a long side Ls and a short side Ss. The light source 65 is disposed with respect to the nozzle surface NM on the side of one end in the direction parallel to the short side Ss of the nozzle surface NM. Further, the detecting element 67 is disposed with respect to the nozzle surface NM on the side of the other end in the direction parallel to the short side Ss of the nozzle surface NM. Note that the light source 65 may be disposed on the side of the other end, and the detecting element 67 may be disposed on the side of one end.

The light source 65 is disposed on the downstream side in the conveyance direction Df of the printing medium W. Further, the detecting element 67 is disposed on the upstream side in the conveyance direction Df of the printing medium W.

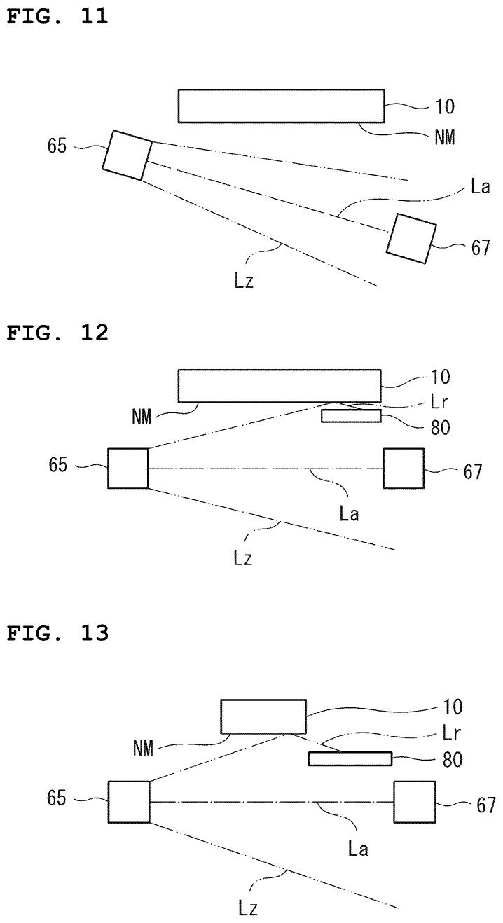

Next, FIG. 11 is a view depicting the emission direction of the laser beam Lz emitted from the light source 65. FIG. 12 is a view depicting an example of a light-shielding part 80 disposed between the nozzle surface NM and the optical axis La. FIG. 13 is a view depicting another example of a light-shielding part 80 disposed between the nozzle surface NM and the optical axis La.

As depicted in FIG. 11, the detecting element 67 is disposed below the light source 65 with respect to the nozzle surface NM. In this case, all or a part of the light source 65 may be disposed above the nozzle surface NM. The light source 65 emits the laser beam Lz toward the detecting element 67 so that the optical axis La is directed obliquely downward with respect to the nozzle surface NM.

As depicted in FIG. 12, the light source 65 and the detecting element 67 are disposed below the nozzle surface NM. In this case, the light source 65 and the detecting element 67 are disposed, for example, outside the nozzle surface NM in a plan view. Note that the light source 65 and the detecting element 67 may be disposed below the nozzle surface NM inside the nozzle surface NM in a plan view.

In general, the ink droplets, which are ejected from the ejection head 10, fly straight only about several millimeters in the ejecting direction in many cases. On this account, the optical axis La is required to be located closely to the nozzle surface NM as much as possible. As a result, the laser beam Lz coming from the light source 65 is reflected by the nozzle surface NM, thereby generating a reflected light. The reflected light is detected by the detecting element 67. In a case where the reflected light is detected by the detecting element 67, the ratio of the laser beam Lz shielded by the ink droplet is decreased, the ratio being included in the total amount of the laser beam Lz coming into the detecting element 67. On this account, the detection process for the ejection failure is less likely to be performed appropriately.

In view of the above situation, with reference to FIG. 12, the light-shielding part 80 is disposed between the nozzle surface NM and the optical axis La of the laser beam Lz coming from the light source 65. That is, the light-shielding part 80 is disposed inside the nozzle surface NM in a plan view. Note that the length of the light-shielding part 80 in the direction parallel to the optical axis La can be appropriately set.

On the other hand, as depicted in FIG. 13, such a configuration is also possible wherein, although the disposition is similar to the disposition depicted in FIG. 12 in that the light-shielding part 80 is provided between the nozzle surface NM and the optical axis La of the laser beam Lz coming from the light source 65, the light-shielding part 80 may be provided below the nozzle surface NM depicted in FIG. 12. That is, the light-shielding part 80 may be disposed outside the nozzle surface NM in a plan view.

Next, FIG. 14 is a view depicting the position of the optical axis La of the light source 65 between one line head 71 and another line head 71 which are adjacent to each other in the transverse direction Dh of the line head 71.

As depicted in FIG. 14, regarding a line head 71A and a line head 71B which are adjacent to each other in the transverse direction D, the light source 65 corresponding to the line head 71A and the detecting element 67 corresponding to the line head 71B are disposed in a disposition area Rp1 as an area between the line head 71A and the line head 71B. Here, in the present embodiment, in two disposition areas Rp1, Rp2 which are adjacent to each other in the transverse direction Dh, the detecting element 67 and the light source 65 are disposed in this order from a location close to one end of the line head 71 in the longitudinal direction DL in the disposition area Rp1. In contrast, the light source 65 and the detecting element 67 are disposed in this order from a location close to one end of the line head 71 in the longitudinal direction DL in the disposition area Rp2.

In the configuration as described above, the optical axis La of the laser beam Lz emitted from the light source 65 in the disposition area Rp1 and the optical axis La of the laser beam Lz emitted from the light source 65 in the other disposition area Rp2 which is adjacent to the disposition area Rp1 in the transverse direction Dh are shifted from each other in the direction crossing the transverse direction Dh.

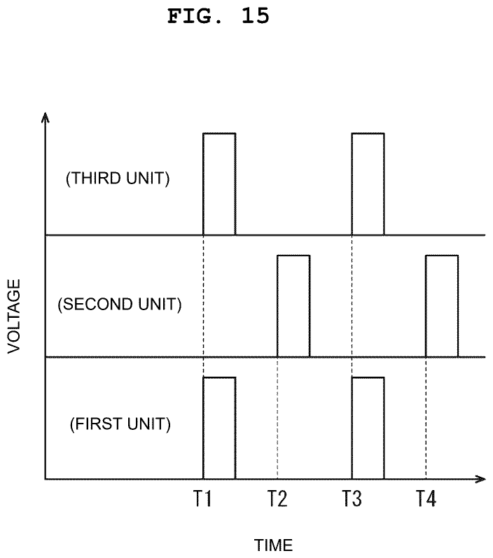

With reference to FIG. 14, for example, a combination of the light source 65 and the detecting element 67 corresponding to the line head 71A is referred to as “unit”, the light source 65 being disposed in the disposition area Rp1 and the detecting element 67 being disposed in the disposition area Rp2 which is adjacent to the disposition area Rp1 in the transverse direction Dh. FIG. 14 depicts a first unit UT1, a second unit UT2, and a third unit UT3 as three units. FIG. 15 is a view depicting the emission timing of the laser beam Lz in each of the units.

In the configuration as described above, as depicted in FIG. 15, the controller 20 shifts the emission timing T1 of the laser beam Lz, emitted from the light source 65 of the first unit UT1 as the light source 65 in the disposition area Rp3, with respect to the emission timing T2 of the laser beam Lz emitted from the light source 65 of the second unit UT2 as the light source 65 in the disposition area Rp1. In this case, the controller 20 may operate such that the emission timing of the laser beam Lz emitted from the light source 65 of the third unit UT3 is the same as the above-described emission timing T1 or is different from the above-described emission timing T1.

As described above, in the present embodiment, the light source 65 is disposed close to one end of the nozzle surface NM in the direction which is parallel to the short side Ss of the nozzle surface NM, and the detecting element 67 is disposed close to the other end of the nozzle surface NM in the direction which is parallel to the short side Ss of the nozzle surface NM. In this case, since the optical path length of the laser beam Lz emitted from the light source 65 can be shortened, the beam diameter of the laser beam Lz can be thinned. With this, the energy density of the laser beam Lz is raised, and the S/N ratio is improved.

In general, a large amount of convection matter such as paper powder, etc., of the printing medium W is present on the downstream side in the conveyance direction Df, and the S/N ratio is lowered in some cases. While the detection sensitivity of the detecting element 67 is difficult to rase, the light source 65 in the present embodiment is disposed on the downstream side in the conveyance direction Df of the printing medium W, and the detecting element 67 is disposed upstream of the printing medium W in the conveyance direction Df. Accordingly, the light emission amount of the light source 65 disposed on the downstream side in the conveyance direction Df is increased, and thus the S/N ratio can be improved.

Further, in the present embodiment, the light source 65 emits the laser beam Lz toward the detecting element 67 so that the optical axis La is directed obliquely downward with respect to the nozzle surface NM. Accordingly, the generation of the reflected light is reduced, which would be otherwise caused by the reflection of the laser beam Lz emitted from the light source 65 by the nozzle surface NM. Accordingly, the S/N ratio is improved in the detecting element 67.

Furthermore, in the present embodiment, the reflected light, which is generated by the reflection of the laser beam Lz emitted from the light source 65 by the nozzle surface NM, is shielded by the light-shielding part 80. Accordingly, the incidence of the reflected light beam into the detecting element 67 is reduced or avoided, and hence the S/N ratio is improved in the detecting element 67.

Moreover, in the present embodiment, regarding the two disposition areas Rp, the optical axis La of the laser beam Lz emitted from the light source 65 in one disposition area Rp of the two disposition areas Rp and the optical axis La of the laser beam Lz emitted from the light source 65 in the other disposition area Rp, of the two disposition areas Rp which is adjacent to the one disposition area Rp in the transverse direction Dh are shifted from each other in the direction crossing the optical axis La. Accordingly, such a situation is reduced or avoided that any scattered light generated in one disposition area Rp is detected by the detecting element 67 disposed in the other disposition area Rp.

Further, in the present embodiment, the controller 20 shifts the emission timing T1 of the laser beam Lz emitted from the light source 65 of the first unit UT1 with respect to the emission timing T2 of the laser beam Lz emitted from the light source 65 of the second unit UT2. Accordingly, the detecting element 67 of each disposition area Rp is less likely to detect any scattered light generated by the light source 65 of another disposition area Rp. With this, the S/N ratio of the detecting element 67 is improved in each disposition area Rp.

What is claimed is:

1. A liquid droplet ejecting apparatus, comprising:
a head having a nozzle surface, the nozzle surface having a plurality of nozzles configured to eject liquid droplets onto a printing medium;
a detecting device having a light source and a detecting element, the light source being configured to emit a light beam toward a flying space through which the liquid droplets ejected from the nozzles fly, the detecting element being disposed such that the flying space is interposed between the detecting element and the light source and configured to detect the light beam;
a rotating device configured to rotate the detecting device about a predetermined center of rotation as a base point, such that an emission direction of the light beam changes in a plane parallel to the nozzle surface;
a moving device configured to move the detecting device in a predetermined outward route direction and a predetermined homeward route direction; and
a controller, wherein
the controller is configured to execute:
a first rotating process of setting the detecting device to a first attitude by causing the rotating device to rotate the detecting device about the center of rotation as the base point, such that an angle of an optical axis of the light beam with respect to the head is a first angle;
a first receiving process of receiving a first light-receiving amount relevant to a first light beam detected by the detecting element by causing the light source to irradiate the liquid droplets ejected from the nozzles to the flying space with the light beam as the first light beam, while causing the moving device to move the detecting device in the first attitude in the outward route direction;
a second rotating process of setting the detecting device to a second attitude by causing the rotating device to rotate the detecting device about the center of rotation as the base point, such that the angle of the optical axis with respect to the head is a second angle which is different from the first angle;
a second receiving process of receiving a second light-receiving amount relevant to a second light beam detected by the detecting element by causing the light source to irradiate the liquid droplets ejected from the nozzles to the flying space with the light beam as the second light beam, while causing the moving device to move the detecting device in the second attitude in the homeward route direction; and
a calculating process of calculating an ejection curvature amount of the liquid droplets with respect to a normal flying direction based on the first light-receiving amount and the second light-receiving amount.

2. The liquid droplet ejecting apparatus according to claim 1, wherein the center of rotation is positioned in a central area of an optical path between the light source and the detecting element.

3. The liquid droplet ejecting apparatus according to claim 1, wherein the light source is disposed close to one end of the head in a longitudinal direction, and the detecting element is disposed close to the other end of the head in the longitudinal direction.

4. The liquid droplet ejecting apparatus according to claim 1, wherein the light source is disposed close to one end of the head in a transverse direction, and the detecting element is disposed close to the other end of the head in the transverse direction.

5. The liquid droplet ejecting apparatus according to claim 1, wherein
multiple heads including the head are disposed at predetermined intervals in a transverse direction of the head,
the light source and the detecting element are disposed with respect to each of the heads, and
between two heads included in the heads and adjacent to each other in the transverse direction of the head, the light source corresponding to one head of the two heads and the detecting element corresponding to the other head of the two heads are aligned in a longitudinal direction of the head.

6. The liquid droplet ejecting apparatus according to claim 1, wherein
multiple heads including the head are disposed at predetermined intervals in a transverse direction of the head,
the light source and the detecting element are disposed with respect to each of the heads, and
between two heads included in the heads and adjacent to each other in the transverse direction of the head,
the light source corresponding to one head of the two heads and the light source corresponding to the other head of the two heads are aligned in a longitudinal direction of the head, or
the detecting element corresponding to the one head and the detecting element corresponding to the other head are aligned in the longitudinal direction of the head.

7. The liquid droplet ejecting apparatus according to claim 1, wherein
the nozzle surface has a long side and a short side,
the light source is disposed close to one end of the nozzle surface in a direction of the short side, and
the detecting element is disposed close to the other end of the nozzle surface in the direction of the short side.

8. The liquid droplet ejecting apparatus according to claim 7, wherein
the light source is disposed downstream in a conveyance direction of the printing medium, with respect to the nozzle surface, and
the detecting element is disposed upstream in the conveyance direction, with respect to the nozzle surface.

9. The liquid droplet ejecting apparatus according to claim 1, wherein
the detecting element is disposed below the light source with respect to the nozzle surface, and
the light source is configured to emit the light beam toward the detecting element obliquely downward with respect to the nozzle surface.

10. The liquid droplet ejecting apparatus according to claim 1, wherein
the light source and the detecting element are disposed below the nozzle surface, and
a light-shielding part is disposed between the nozzle surface and the optical axis of the light beam emitted from the light source.

11. The liquid droplet ejecting apparatus according to claim 4, wherein
multiple heads including the head are disposed at predetermined intervals in the transverse direction of the head,
in a disposition area between two heads included in the heads and adjacent to each other in the transverse direction of the head, the light source corresponding to one head of the two heads and the detecting element corresponding to the other head of the two heads are disposed, and
the optical axis of the light beam emitted from the light source in the disposition area and the optical axis of the light beam emitted from the light source in another disposition area, which is adjacent to the disposition area in the transverse direction of the head, are shifted from each other in a direction crossing the transverse direction of the head.

12. The liquid droplet ejecting apparatus according to claim 4, wherein
multiple heads including the head are disposed at predetermined intervals in the transverse direction of the head,
the light source and the detecting element are disposed with respect to each of the heads,
in a disposition area between two heads included in the heads and adjacent to each other in the transverse direction of the head, the light source corresponding to one head of the two heads and the detecting element corresponding to the other head of the two heads are disposed, and
the controller is configured to cause an emission timing of the light beam emitted from the light source in the disposition area to be shifted from an emission timing of the light beam emitted from the light source in another disposition area which is adjacent to the disposition area in the transverse direction of the head.
